(19) United States
(12) Patent Application Publication
(10) Pub. No.: US 2019/0363910 A1
(43) Pub. Date: Nov. 28, 2019

(54) Use of Mobility Reference Signals to Perform Radio Link Monitoring in a Beam-Based System

(71) Applicant: Telefonaktiebolaget LM Ericsson (publ), Stockholm (SE)

(72) Inventors: Umut UGURLU, Cambridge (GB); Icaro L. J. DA SILVA, Solna (SE); Rui FAN, Beijing (CN); Pradeepa RAMACHANDRA, Linköping (SE); Claes TIDESTAV, Bålsta (SE)

(21) Appl. No.: 15/743,450

(22) PCT Filed: Nov. 3, 2017
(86) PCT No.: PCT/SE2017/051101

§ 371 Date: Jan. 10, 2018

Related U.S. Application Data
(60) Provisional application No. 62/417,799, filed on Nov. 4, 2016.

(51) Int. Cl. H04L 25/02; H04L 5/00; H04B 17/309; H04W 24/06; H04W 24/10

(52) U.S. Cl. CPC H04L 25/0224; H04L 5/0048; H04B 7/0617; H04W 24/06; H04W 24/10; H04B 17/309

(57) ABSTRACT

According to an aspect, an access node transmits, in a downlink signal having a series of subframes, a beam-formed reference signal in each of a plurality of subframes, where the beam-formed reference signals are received in fewer than all of the subframes of the downlink signal and are for use by one or more user equipments, UEs, in performing mobility management. The access node also transmits, for a wireless device, a UE-specific RS, which may be different than the beam-formed reference signals, for use by a UE in performing RLM. The UE receives the beam-formed reference signals and the UE-specific RS. The UE then performs mobility management measurements using the beam-formed reference signals and performs RLM using the UE-specific RS.

### TECHNICAL BACKGROUND

The present disclosure is generally related to wireless communications systems, and is more particularly related to access nodes that configure wireless devices to perform radio link monitoring (RLM) in such systems.

### BACKGROUND

Radio Link Monitoring (RLM) in LTE

The Long-Term Evolution (LTE) wireless system developed by the 3^{rd}-Generation Partnership Project (3GPP) is a widely deployed fourth-generation wireless communications system. In LTE and its predecessor systems, the purpose of the RLM function in a wireless device, referred to in 3GPP documentation as a “user equipment,” or “UE,” is to monitor the downlink radio link quality of the serving cell in RRC_CONNECTED mode. This monitoring is based on Cell-Specific Reference Signals (CRS), which are always associated to a given LTE cell and are derived from the Physical Cell Identifier (PCI). RLM in turn enables the UE, when in RRC_CONNECTED mode, to determine whether it is in-sync or out-of-sync with respect to its serving cell, as described in 3GPP TS 36.213, v14.0.0.

The UE's estimate of the downlink radio link quality, based on its measurements of the CRS, is compared with out-of-sync and in-sync thresholds, Qout and Qin respectively, for the purposes of RLM. These thresholds are standardized in terms of the Block Error Rate (BLER) of a hypothetical Physical Downlink Control Channel (PDCCH) transmission from the serving cell. Specifically, Qout corresponds to a 10% BLER, while Qin corresponds to a 2% BLER. The same threshold levels are applicable whether Discontinuous Reception (DRX) is in use or not.

The mapping between the CRS-based downlink quality and the hypothetical PDCCH BLER is up to the UE implementation. However, the performance is verified by conformance tests defined for various environments, as described in 3GPP TS 36.521-1, v14.0.0. Also, the downlink quality is calculated based on the Reference Signal Receive Power (RSRP) of CRS over the whole band, as illustrated in FIG. 1, since PDCCH is transmitted over the whole band.

When no DRX is configured, out-of-sync occurs when the downlink radio link quality estimated over the last 200-millisecond period becomes worse than the threshold Qout. Similarly, without DRX, the in-sync occurs when the downlink radio link quality estimated over the last 100-millisecond period becomes better than the threshold Qin. Upon detection of out-of-sync, the UE initiates the evaluation of in-sync. The occurrences of out-of-sync and in-sync are reported internally by the UE's physical layer to its higher layers, which in turn may apply layer 3 (i.e., higher layer) filtering for the evaluation of Radio Link Failure (RLF). The higher-layer RLM procedure is illustrated in FIG. 2.

When DRX is in use, the out-of-sync and in-sync evaluation periods are extended, to enable sufficient UE power saving, and depend upon the configured DRX cycle length. The UE starts in-sync evaluation whenever out-of-sync occurs. Therefore, the same period (TEvaluate_Qout_DRX) is used for the evaluation of out-of-sync and in-sync. However, upon starting the RLF timer (T310) until its expiry, the in-sync evaluation period is shortened to 100 milliseconds, which is the same as without DRX. If the timer T310 is stopped due to N311 consecutive in-sync indications, the UE performs in-sync evaluation according to the DRX based period (TEvaluate_Qout_DRX).

The whole methodology used for RLM in LTE (i.e., measuring the CRS to “estimate” the PDCCH quality) relies on the assumption that the UE is connected to an LTE cell, a single connectivity entity transmitting both PDCCH and CRSs.

5G Development

In a study item for the new 5G radio access technology, entitled New Radio (NR), companies have reached initial agreements on the following design principles: ultra-lean design for NR; and massive usage of beamforming. Companies have expressed the view that beamforming should be taken into account when RLM is designed, which is not the case in LTE. In addition, concerns have been expressed regarding how the UE should measure the quality of a cell.

Following are some of the principles of NR that may drive the need for new solutions for RLM, compared to the existing solution in LTE. Also described are some aspects of the beam-based mobility solution for NR using RRC signaling across transmission receiving points (TRPs) that are unsynchronized and/or not sharing the same baseband and/or linked via non-ideal backhaul.

Ultra-Lean Design in 5G NR

NR is expected to be an ultra-lean system, which implies a minimization of always-on transmissions, aiming for an energy efficient future-proof system. Early agreements in 3GPP show that this principle has been endorsed and there is a common understanding that NR should be a lean system. In RAN1#84bis, RAN1 agreed, regarding ultra-lean design, that NR shall strive for maximizing the amount of time and frequency resources that can be flexibly utilized or left blanked, without causing backward compatibility issues in the future.

Blank resources can be used for future use. NR shall also strive for minimizing transmission of always-on signals and confining signals and channels for physical layer functionalities (signals, channels, signaling) within a configurable/allocable time/frequency resource.

Beamforming In 5G NR

There is a common understanding that NR will consider frequency ranges up to 100 GHz. In comparison to the current frequency bands allocated to LTE, some of the new bands will have much more challenging propagation properties such as lower diffraction and higher outdoor/indoor penetration losses. Consequently, signals will have less ability to propagate around corners and penetrate walls. In addition, in high frequency bands, atmospheric/rain attenuation and higher body losses render the coverage of NR signals even spottier. Fortunately, operation in higher frequencies makes it possible to use smaller antenna elements, which enables antenna arrays with many antenna elements. Such antenna arrays facilitate beamforming, where multiple antenna elements are used to form narrow beams and thereby compensate for the challenging propagation properties. For these reasons, it is widely accepted that NR will rely on beamforming to provide coverage, which means that NR is often referred to as a beam-based system.

It is also known that different antenna architectures should be supported in NR: analog, hybrid and digital. This implies some limitations in terms of how many directions can be covered simultaneously, especially in the case of analog/hybrid beamforming. To find a good beam direction at a given transmission point (TRP)/access node/antenna array, a beam-sweep procedure is typically employed. A typical example of a beam-sweep procedure is that the node points a beam containing a synchronization signal and/or a beam identification signal, in each of several possible directions, one or few direction(s) at a time. This is illustrated in FIG. 3, where each of the illustrated lobes represents a beam, and where the beams may be transmitted consecutively, in a sweeping fashion, or at the same time, or in some combination. If the same coverage properties apply to both a synchronization signal and beam identification signal in each beam, the UE can not only synchronize to a TRP but also gain the best beam knowledge at a given location.

As described above, common signals and channels in LTE are transmitted in an omnidirectional manner, i.e., without beamforming. In NR, with the availability of many antennas at the base station and the different ways they can be combined to beamform signals and channels, that assumption, as made in LTE, may no longer be valid. The major consequence of that design principle of NR beamforming is that while in LTE it was quite clear that the CRSs quality could be used to estimate the quality of PDCCH, in NR this becomes unclear, due to the different ways channels and reference signals can be beamformed. In other words, it cannot be assumed as a general matter that any particular reference signal will be transmitted in the same manner as the PDCCH is transmitted. This ambiguity from the UE's point of view is due to the fact that reference signals and channels can be transmitted by the network via different kinds of beamforming schemes, which are typically determined based on real-time network requirements. These requirements may include, for example, different tolerance levels to radio overhead due to reference signals versus control channels, or different coverage requirements for reference signals versus control channels.

Despite these challenges from NR design principles, an NR UE in connected mode still needs to perform RLM, to verify whether its cell quality is still good enough, so that the UE can be reached by the network. Otherwise, higher layers should be notified, and UE autonomous actions should be triggered.

Mobility Reference Signal in NR: 3GPP Agreements

In 3GPP discussions, certain aspects have been agreed to for mobility reference signals (MRSs), which are used by the UE in NR for measurements related to mobility (e.g., handover, or HO). For downlink-based mobility in RRC_CONNECTED mode involving radio resource control (RRC) and beams, the UE measures at least one or more individual beams, and the gNB (3GPP terminology for an NR base station) should have mechanisms to consider those beams to perform HO. This is necessary at least to trigger inter-gNB handovers and to avoid HO ping-pongs/HO failures. It is to be determined whether UEs will report individual and/or combined quality of multiple beams. The UE should also be able to distinguish between the beams from its serving cell and beams from non-serving cells for Radio Resource Management (RRM) measurements in active mobility. The UE should be able to determine whether a beam is from its serving cell. It is yet to be determined whether serving/non-serving cell may be termed “serving/non-serving set of beams,” whether the UE is informed via dedicated signalling or implicitly detected by the UE based on some broadcast signals, how the cell in connected relates to the cell in idle, and how to derive a cell quality based on measurements from individual beams.

Multiple solutions for the specific design of the MRS are being considered, but in any of these, the UE performs RRM measurements within its serving cell via a set of MRSs. The UE is aware of the specific MRS that belongs to its serving cell, so that all other reference signals the UE may detect are assumed to be neighbors.

The transmission strategy for reference signals like MRSs can utilize the freedom in time and/or frequency and/or the code/sequence dimension. By transmitting the reference signals for different beams in orthogonal resources, the network can obtain distinct measurement reports corresponding to these signals from the UE corresponding to the orthogonal reference signals.

### SUMMARY

As described above, RLM in LTE is based on CRSs, where a wide-band signal is transmitted in all subframes. A major consequence of the lean-design principle with respect to the RLM design in NR is that there is a wish to avoid the design of wide-band signals transmitted in all subframes. Therefore, lean design will prohibit the usage of the same LTE solution for RLM in NR.

Described in detail below are techniques by which a wireless device (e.g., UE) can measure its serving cell quality where a cell is transmitting signals in a beamforming manner in a lean design, i.e., without always-on reference signals transmitted in the whole band and across all subframes.

Embodiments of the present techniques include methods at a UE and a network radio access node, where the UE performs RLM in a system with beamforming by performing RRM measurements based on a UE-specific Reference Signal (RS), which may be different from the periodic RSs configured to support connected mode mobility. This enables the network to possibly beamform the downlink control channel (e.g., PDCCH) in a different manner compared to the reference signals used to support connected mode mobility, such as in a narrow beam to reach the UE far away, where it is out of the coverage of the reference signals used to support connected mode mobility.

At the network side, the radio access node has the flexibility to beamform the downlink control channel information in a completely different way as compared to the reference signals used to support connected mode mobility. What is matched then is the way the network transmits the downlink control channels and UE-specific RSs designed for RLM purposes. The network may also transmit these UE-specific RSs in the same search space or in an adjacent search space of the downlink control channel for a given UE.

In the context of the present disclosure, “performing RLM” means performing RRM measurements and comparing the value of a given metric, e.g., a signal-to-interference-plus-noise ratio (SINR), with a threshold that represents the downlink control channel quality under the assumption that the control channel would have been transmitted in the same manner, i.e., with similar beamforming properties and/or similar or representative frequency resources.

Advantages of the above approach include the ability of the network to be flexible in beamforming transmit downlink control channels different than the reference signals used to support connected mode mobility, to fulfill the coverage requirements associated with the downlink control channel coverage, on which RLM should be based. Also, since the RSs are UE-specific, the network has the flexibility to configure multiple UEs with the same UE-specific RS for the RLM purpose, as long as they match the same downlink control channel search space/bandwidth. This can be the same RS used for downlink control channel demodulation (e.g., DMRS) or an additional RS.

According to some embodiments, a method in a UE operating in a wireless network includes receiving, in a downlink signal having a series of subframes, a UE-specific RS, and performing RLM using the UE-specific RS. In some embodiments, the method further comprises receiving a beam-formed reference signal in each of a plurality of subframes, where the beam-formed reference signals are received in fewer than all of the subframes of the downlink signal, and performing mobility management measurements using the beam-formed reference signals. The beam-formed reference signals may be different from the UE-specific reference signal. The downlink signal may include one or more control channels.

According to some embodiments, a method in an access node of a wireless communications system includes configuring, for a UE, a UE-specific reference signal, and transmitting, in a downlink signal having a series of subframes, the UE-specific RS, for use by the first UE in performing RLM. In some embodiments, the method further comprises transmitting a beam-formed reference signal in each of a plurality of subframes, where the beam-formed reference signals are transmitted in fewer than all of the subframes of the downlink signal, for use by one or more UEs, in performing mobility management. Again, the beam-formed reference signals may be different from the UE-specific RS.

According to some embodiments, a UE operating in a wireless network includes transceiver circuitry and processing circuitry operatively associated with the transceiver circuitry. The processing circuitry is configured to receive, in a downlink signal having a series of subframes, a UE-specific RS, and to perform RLM using the UE-specific RS. In some embodiments, the processing circuitry is further configured to receive a beam-formed reference signal in each of a plurality of subframes, such that the beam-formed reference signals are received in fewer than all of the subframes of the downlink signal, and perform mobility management measurements using the beam-formed reference signals.

According to some embodiments, an access node of a wireless communications system includes transceiver circuitry and processing circuitry operatively associated with the transceiver circuitry. The processing circuitry is configured to configure, for a first UE, a UE-specific reference signal, and transmit, in a downlink signal having a series of subframes, the UE-specific RS, for use by the first UE in performing RLM. In some embodiments, the processing circuitry is further configured to transmit a beam-formed reference signal in each of a plurality of subframes, wherein the beam-formed reference signals are transmitted in fewer than all of the subframes of the downlink signal, for use by one or more UEs in performing mobility management.

Further aspects of the present invention are directed to an apparatus, computer program products or computer readable storage medium corresponding to the methods summarized above and functional implementations of the above-summarized apparatus and UE.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE FIGURES

FIG. 1 illustrates how PDCCH can be scheduled anywhere over the whole downlink transmission bandwidth.

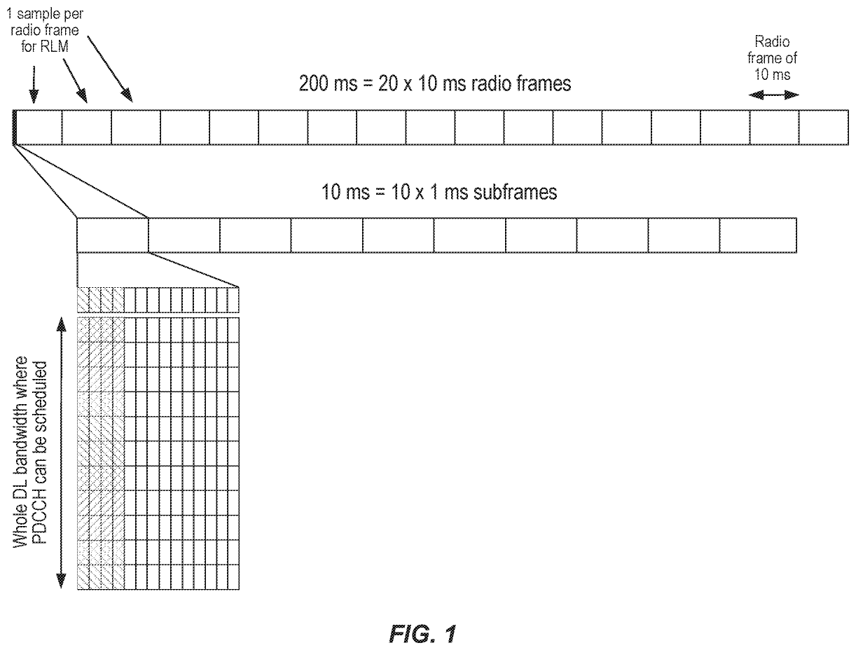

FIG. 2 illustrates higher layer RLM procedures in LTE.

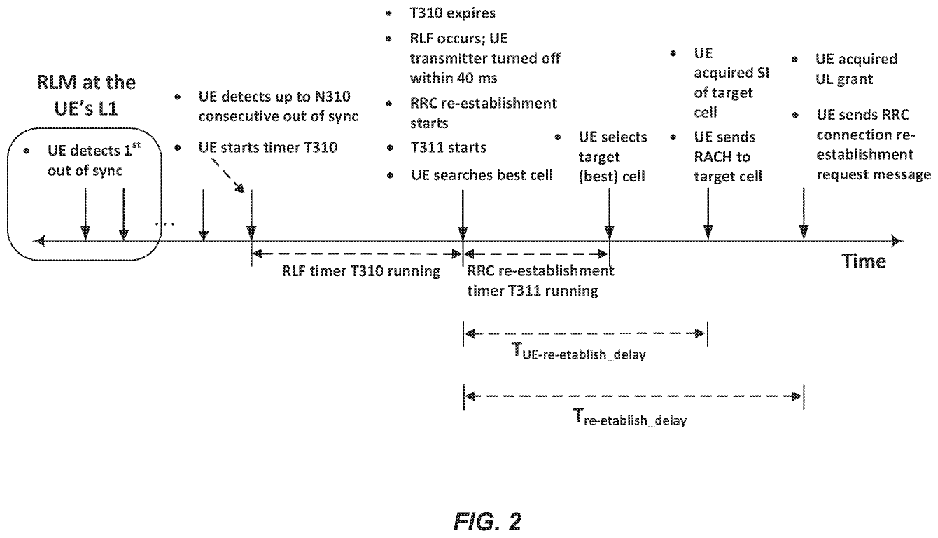

FIG. 3 illustrates a beam sweeping procedure.

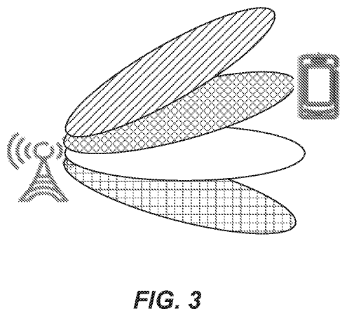

FIG. 4 illustrates the generation of a single MRS.

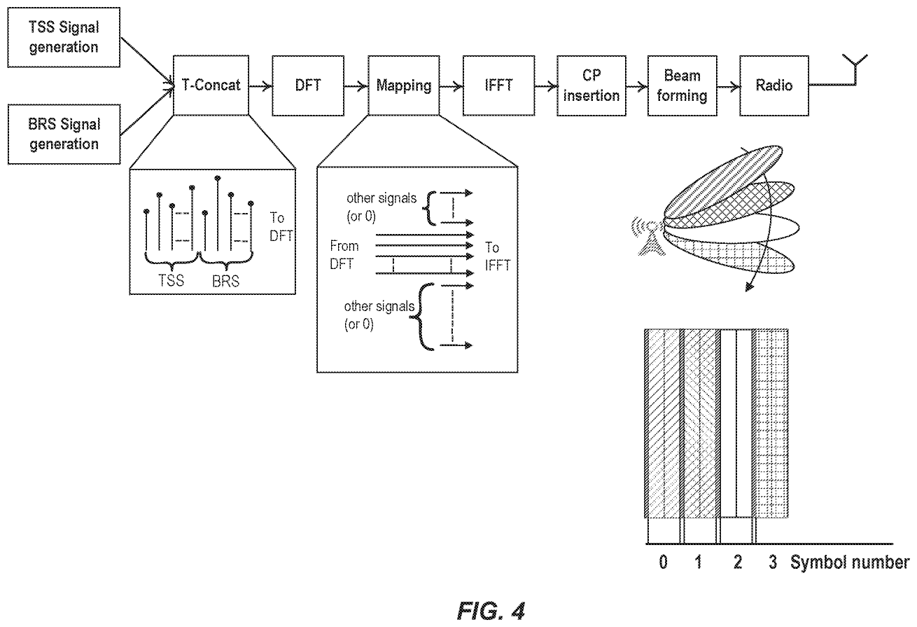

FIG. 5 illustrates an MRS design in time and frequency domains.

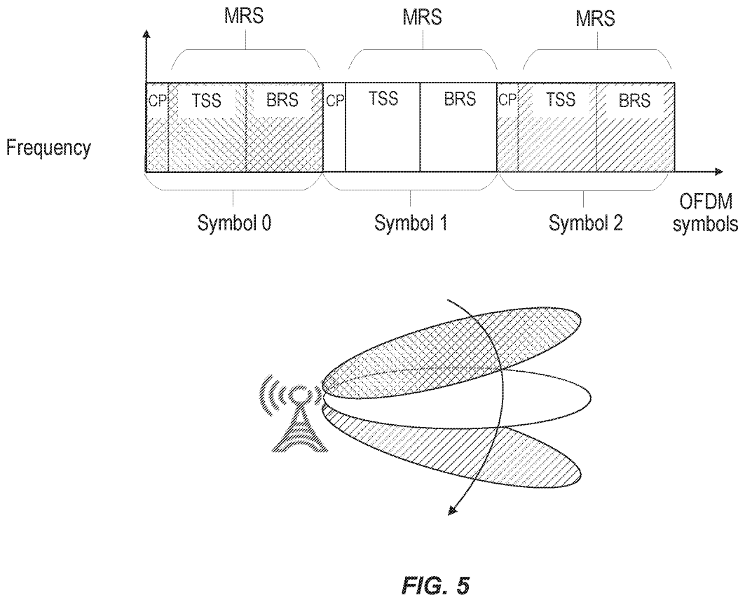

FIG. 6 illustrates the principles of a reference signal transmission that facilitates RLM procedures described herein.

FIG. 7 is a diagram illustrating that RSs used for mobility can be transmitted on six adjacent PRBs in every fifth subframe.

FIG. 8 is a diagram illustrating another example of how the MRSs may be transmitted, to support both mobility measurements and RLM.

FIG. 9 is a diagram illustrating an example where the additional RSs at F2 and F3 are offset from one another.

FIG. 10 is a diagram illustrating that the configuration of six different physical resource block (PRB) allocations for the serving MRS set can be different for different access nodes and matched to different access node IDs.

FIG. 11 is a block diagram of a network node, according to some embodiments.

FIG. 12 illustrates a method in the network node, according to some embodiments.

FIG. 13 is a block diagram of a wireless device, according to some embodiments.

FIG. 14 illustrates a method in the wireless device, according to some embodiments.

FIG. 15 is a diagram illustrating beamforming with a control channel with respect to reference signals, according to some embodiments.

FIG. 16 is a diagram illustrating periodicity of DMRS transmissions, according to some embodiments.

FIG. 17 is a diagram illustrating PDCCH transmissions with respect to DMRS transmissions, according to some embodiments.

FIG. 18 is a block diagram illustrating a functional implementation of a network node, according to some embodiments.

FIG. 19 is a block diagram illustrating a functional implementation of a wireless device, according to some embodiments.

### DETAILED DESCRIPTION

In the following, concepts in accordance with exemplary embodiments of the invention will be explained in more detail and with reference to the accompanying drawings. The illustrated embodiments relate to radio link monitoring in such a wireless communication network, as performed by wireless devices, in the following also referred to as UEs, and access nodes. The wireless communication network may for example be based on a 5G radio access technology (RAT), such as an evolution of the LTE RAT or the 3GPP New Radio (NR). However, it is to be understood that the illustrated concepts could also be applied to other RATs.

An example NR system may include a UE and a network radio access node, where the UE performs RLM in a system with beamforming by performing RRM measurements based on the same periodic reference signals configured to support connected mode mobility (MRSs). At the network side, the radio access node transmits downlink control channel information in the same way it transmits these reference signals to be reused for RLM purposes. Note that as used herein, the terms “MRS” and “mobility reference signal” are used to refer to reference signals configured to and/or used to support connected mode mobility, i.e., for measurement by UEs to determine when handovers to other beams and/or cells. It will be appreciated that some or all of these reference signals may be used for other purposes as well, and these reference signals may be known by other names.

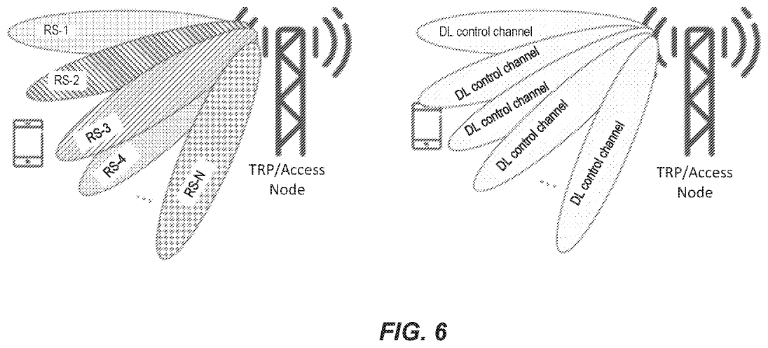

FIG. 6 illustrates the principles of a reference signal transmission that facilitate the RLM procedures described herein. As seen on the left-hand side of FIG. 6, each beam carries RSs that are configured to the wireless device (e.g., UE). What is meant by “configured to the UE” is that a UE in RRC_CONNECTED mode is provided with information regarding measurements and reporting conditions, with respect to serving cell/beam signals and/or non-serving cell/beam signals. In some embodiments, the RSs may carry a BID, a beam ID plus a group ID (which may be understood as a cell ID, for example), or simply a group ID, in various embodiments. As seen on the right-hand side of FIG. 6, a downlink control channel, e.g., a PDCCH, is transmitted using the same beamforming properties as the RSs. This may be understood as transmitting the downlink control channel in the “same beam” as the RSs, even if transmitted at different times. Note that the downlink control channel can carry (or be associated with) different RSs for channel estimation and channel decoding purposes. As a general matter, these can be, but are not necessarily, completely separate from the ones used for mobility, and may be cell-specific, UE-specific, and/or beam-specific, in various embodiments.

Given the approach shown in FIG. 6, it will be understood that RLM could be carried out on the MRSs, i.e., the RSs RS-1 to RS-N, since because the downlink control channel is beamformed in the same way as the MRSs, the measured quality of the MRSs will directly correspond to a quality of the downlink control channel. Thus, thresholds for in-sync and out-of-sync detection could be utilized in the same way as in LTE.

However, in order to fulfill requirements for RRM measurements, these MRSs have been envisioned to be narrow band signal (e.g., 6 central physical resource blocks (PRBs)). On the other hand, the downlink control channel can either be transmitted in the whole band (as LTE PDCCH) or localized/distributed (as LTE ePDCCH and possibly the downlink control channel design in NR).

In the case of localized downlink control channels, the system could transmit MRSs in some representative resource blocks whose quality is correlated with the quality of the UE search spaces for the downlink control channel. However, in the case of non-localized/distributed downlink control channels, that technique would provide some inaccuracies in the sense that while the MRS bandwidth is confined to a limited number of PRBs, the downlink control channel band or the UE-specific search space may expend to much wider bandwidths so that there might be a limited accuracy of the downlink control channel quality estimation based on the MRSs.

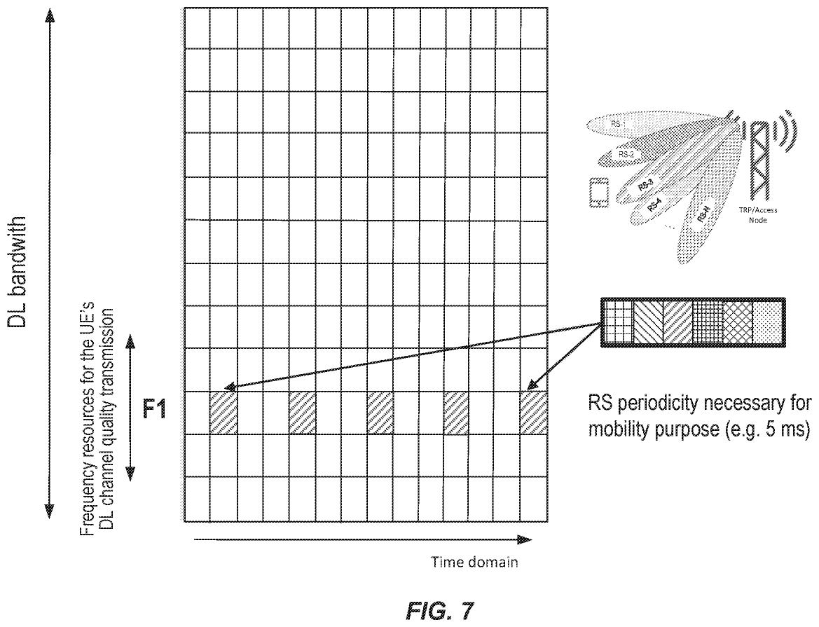

One approach to address this is for the access node to configure the UE to perform RLM measurements based on a new signal that is a version of the MRSs, but repeated in the frequency domain in the same frequency resources of the search space of the downlink control channel of a given UE. These multiple versions of the MRSs may also be transmitted in different subframes in order to provide some additional time domain diversity and/or to enable the beamforming transmission to be equivalent. FIG. 7 illustrates an example of RS periodicity.

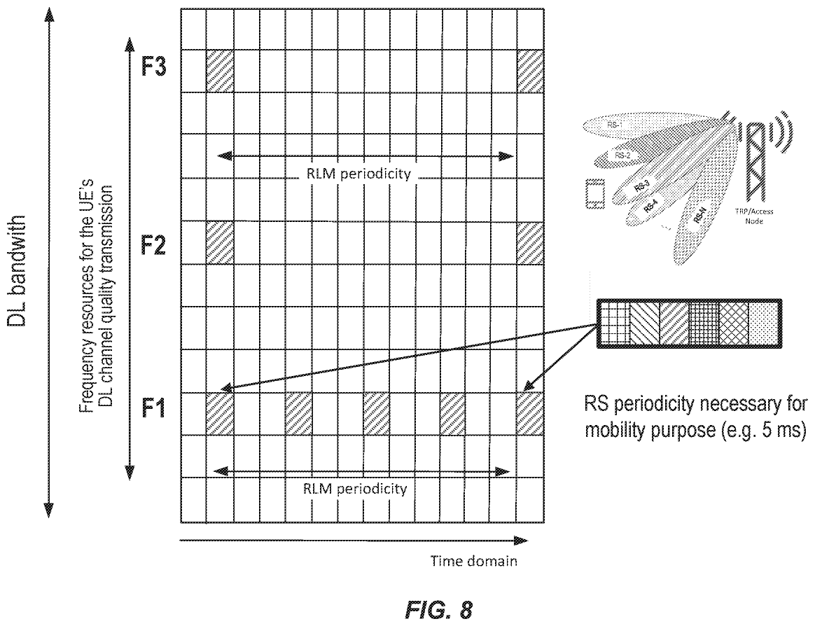

FIG. 8 illustrates an example of how the MRSs could be transmitted to support both mobility measurements and RLM. In the illustrated example, MRSs are transmitted in frequency resources localized at F1, at a relatively frequency periodicity, e.g., 5 milliseconds, for mobility measurement purposes. The UE may be configured with configuration information specifying these time-frequency resources, e.g., with a parameter specifying F1, a parameter indicating a 5 milliseconds periodicity, etc., and then use the RSs transmitted in these time-frequency resources for mobility measurements. Note that F1, F2, s15 F3, etc., may indicate a set or range of subcarriers in some embodiments. For example, the MRSs may occupy six adjacent PRBs at each of the locations in the frequency band indicated by F1, F2, and F3 in the figure. Configuration parameters provided to the UE, e.g., by RRC signaling, may indicate a center frequency, lower frequency, or some other pointer to a frequency position or range, and may, in some embodiments, even indicate a bandwidth across which a localized group of RSs are transmitted.

In FIG. 8, the RSs at F1 are provided for mobility measurement purposes, and have a periodicity sufficient for these purposes. The example configuration shown in FIG. 8 also includes additional RSs, of the same type, but at different frequencies F2 and F3, and with a different periodicity. Placing these RSs at different frequencies, however, allows for the RLM to be more accurately correlated with downlink control channel transmissions, e.g., in the case where the downlink control channel or control channel search space is distributed across the frequency band.

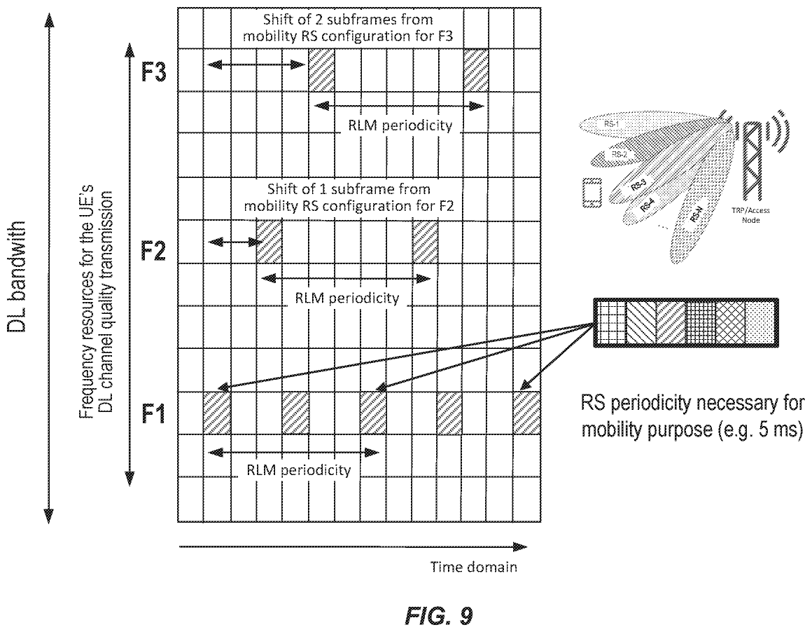

Note that while it may be convenient in some embodiments for the periodicity of the additional RSs to be an integer multiple of the RSs used for mobility purposes, this is not necessarily the case. Also, while the additional RSs at F2 and F3 in FIG. 8 are shown as coinciding in time with some of the RSs at F1, this again is not necessarily the case—these may be offset in time, in some embodiments. This is the case with the example configuration shown in FIG. 9.

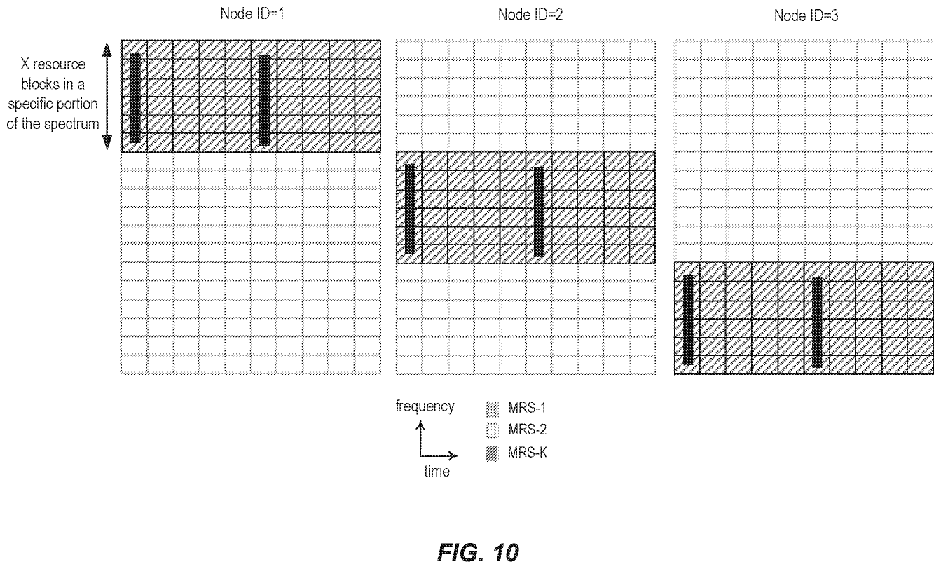

The transmission of the MRSs used for mobility can be configured sparsely for RRM and synchronization functions in the time and frequency domains, to match the downlink control channel quality. For example, the MRSs can be transmitted on six adjacent PRBs in every fifth subframe, as illustrated in FIG. 10.

One aspect of the techniques described above is that the network transmits these RSs to be used for mobility and for RLM in frequency resources that are correlated (i.e., overlapping or closely corresponding in frequency) with those where the downlink control channel is being transmitted. Thus, because the RSs are transmitted using the same beamforming properties as those applied to the downlink control channel, the result is that the RS quality is both correlated in the directional domain (which might be referred to as “the beam domain”) and in the frequency domain, regardless of any further time averaging that may occur.

However, because the downlink control channels are beamformed in a similar manner as the downlink MRS, the network defines the transmission of MRSs in narrow beams, and it also has to transmit the downlink control channel in the same narrow beam. Otherwise, the UE would not perform an accurate enough downlink control channel estimation, leading to inaccurate RLM. If the network transmits downlink control channel in a different beamforming manner (e.g. in a very narrow beams), the UE may simply assume the downlink control channel quality is bad when, in fact, it is actually still reachable. The network would then need to transmit the downlink control channel in a similar beamforming manner as it transmits the MRSs. This reduces the flexibility of the beamformer.

Embodiments of the present invention, therefore, modify the techniques described above and provide a method at a UE and a network radio access node where the UE performs RLM in a system with beamforming by performing RLM measurements based on a UE-specific RS, which may be different from the reference signals used to support mobility, i.e., the MRSs, in order to enable the network to beamform the downlink control channel in a different manner compared to MRSs. This may be the case when narrow beams are used to reach the UE far away, where it is out of the coverage of the MRSs.

At the network side, the radio access node would now have the flexibility to beamform the downlink control channel information in a completely different way compared to the reference signals used to support mobility. What needs to be matched now is the way the network transmits the downlink control channels and these UE-specific RSs that are designed for RLM purposes. The network may also transmit these UE-specific RSs in the same search space of the downlink control channel for a given UE.

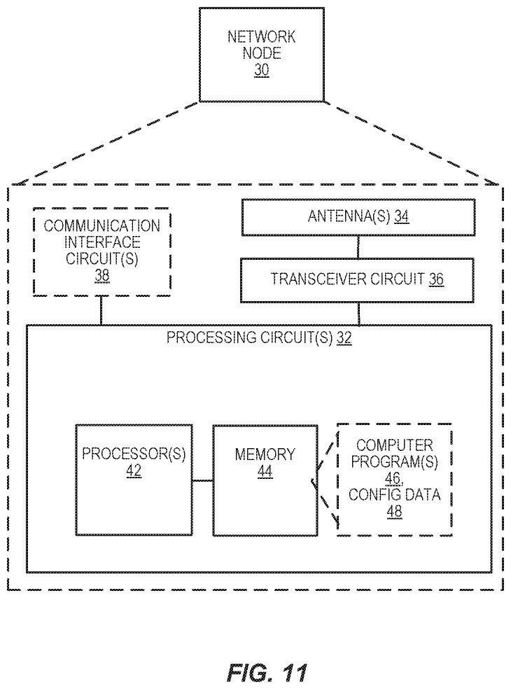

FIG. 11 illustrates a diagram of a network node 30 that may be configured to carry out one or more of the disclosed techniques. The network node 30 can be any kind of network node that may include a network access node such as a base station, radio base station, base transceiver station, evolved Node B (eNodeB), Node B, gNB, or relay node. In the non-limiting embodiments described below, the network node 30 will be described as being configured to operate as a cellular network access node in an NR network.

Those skilled in the art will readily appreciate how each type of node may be adapted to carry out one or more of the methods and signaling processes described herein, e.g., through the modification of and/or addition of appropriate program instructions for execution by processing circuits 32.

The network node 30 facilitates communication between wireless terminals, other network access nodes and/or the core network. The network node 30 may include a communication interface circuit 38 that includes circuitry for communicating with other nodes in the core network, radio nodes, and/or other types of nodes in the network for the purposes of providing data and/or cellular communication services. The network node 30 communicates with UEs using antennas 34 and a transceiver circuit 36. The transceiver circuit 36 may include transmitter circuits, receiver circuits, and associated control circuits that are collectively configured to transmit and receive signals according to a radio access technology, for the purposes of providing cellular communication services.

The network node 30 also includes one or more processing circuits 32 that are operatively associated with the transceiver circuit 36 and, in some cases, the communication interface circuit 38. For ease of discussion, the one or more processing circuits 32 are referred to hereafter as “the processing circuit 32” or “the processing circuitry 32.” The processing circuit 32 comprises one or more digital processors 42, e.g., one or more microprocessors, microcontrollers. Digital Signal Processors (DSPs), Field Programmable Gate Arrays (FPGAs), Complex Programmable Logic Devices (CPLDs), Application Specific Integrated Circuits (ASICs), or any mix thereof. More generally, the processing circuit 32 may comprise fixed circuitry, or programmable circuitry that is specially configured via the execution of program instructions implementing the functionality taught herein, or may comprise some mix of fixed and programmed circuitry. The processor 42 may be multi-core, i.e., having two or more processor cores utilized for enhanced performance, reduced power consumption, and more efficient simultaneous processing of multiple tasks.

The processing circuit 32 also includes a memory 44. The memory 44, in some embodiments, stores one or more computer programs 46 and, optionally, configuration data 48. The memory 44 provides non-transitory storage for the computer program 46 and it may comprise one or more types of computer-readable media, such as disk storage, solid-state memory storage, or any mix thereof. Here, “non-transitory” means permanent, semi-permanent, or at least temporarily persistent storage and encompasses both long-term storage in non-volatile memory and storage in working memory, e.g., for program execution. By way of non-limiting example, the memory 44 comprises any one or more of SRAM, DRAM, EEPROM, and FLASH memory, which may be in the processing circuit 32 and/or separate from the processing circuit 32. In general, the memory 44 comprises one or more types of computer-readable storage media providing non-transitory storage of the computer program 46 and any configuration data 48 used by the network access node 30. The processing circuit 32 may be configured, e.g., through the use of appropriate program code stored in memory 44, to carry out one or more of the methods and/or signaling processes detailed hereinafter.

The network node 30 is configured, according to some embodiments, to operate as an access node of a wireless communications system that provides for a UE to measure its serving cell quality where the cell is transmitting signals in a beamforming manner. The processing circuit 32 is configured to transmit, in a downlink signal having a series of subframes, a beam-formed reference signal in each of a plurality of subframes, where the beam-formed reference signals are received in fewer than all of the subframes of the downlink signal and is for use by one or more UEs in performing mobility management. The processing circuit 32 is also configured to transmit, for a first UE, a UE-specific RS, for use by the first UE in performing RLM. The UE-specific RS may be different from the beam-formed reference signals.

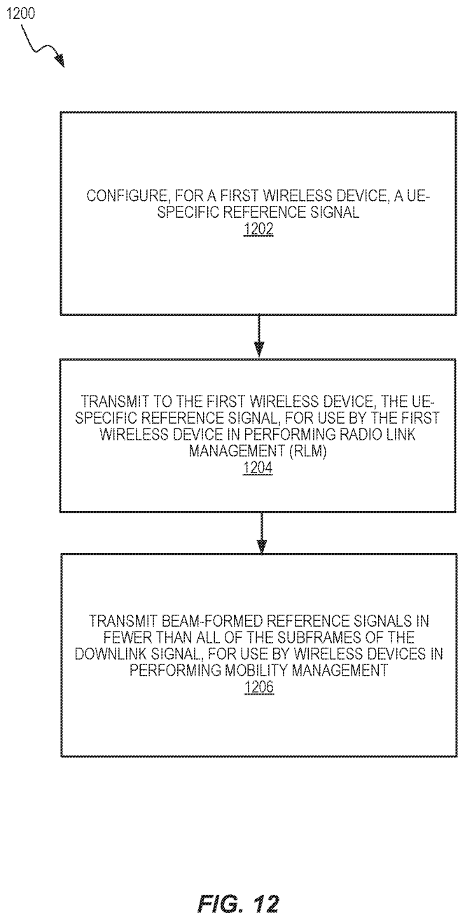

Regardless of the physical implementation, the processing circuit 32 is configured to perform, according to some embodiments, a method 1200 in an access node 30 of a wireless communications system, as shown in FIG. 12. The method 1200 includes configuring, for a first UE, a UE-specific reference signal, RS (block 1202), and transmitting, in a downlink signal having a series of subframes, the UE-specific RS, for use by the first UE in performing RLM (block 1204). As shown in the figure, the method may also comprise transmitting beam-formed reference signal in each of a plurality of subframes, where the beam-formed reference signals are transmitted in fewer than all of the subframes of the downlink signal, for use by one or more UEs in performing mobility management (block 1206). The beam-formed reference signals may be different from the UE-specific RS, in some embodiments.

In some embodiments, the UE-specific RS may include demodulation reference symbols (DMRS) in a control channel region (e.g., PDDCH) of the downlink signal and associated with a control channel message (e.g., downlink control information (DCI)) for the UE. The UE-specific RS may then be transmitted using the same beamforming parameters as applied to the control channel message. For example, the UE-specific RS may be the same as the DMRS and beamformed in the same manner as PDCCH. Using these DMRS, the hypothetical PDCCH quality estimate is rather accurate (compared to the actual PDCCH demodulation based on the DMRS).

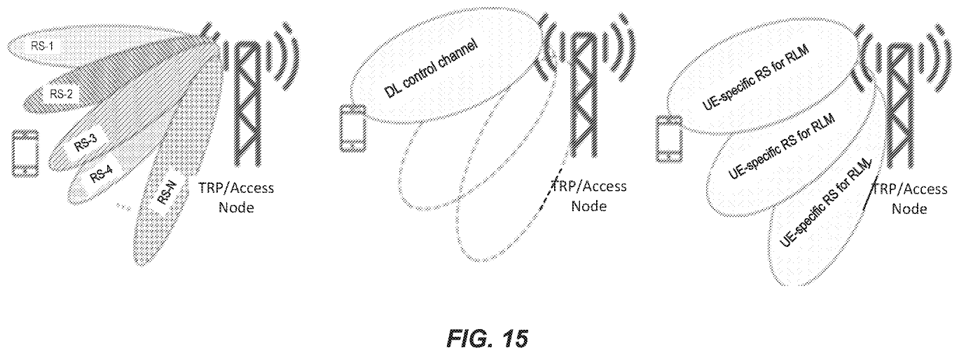

The flexibility afforded the network by such embodiments is illustrated in FIG. 15. FIG. 15 is a diagram illustrating beamforming with a control channel with respect to reference signals, according to some embodiments. The left diagram shows beamformed reference signals used for mobility, i.e., MRSs, where the MRSs can either carry a beam ID, a beam ID+group ID (e.g., cell ID), or simply a group ID. The middle diagram of FIG. 15 shows a DL control channel transmitted in possibly different beams compared to MRSs. The right diagram of FIG. 15 shows UE-specific RSs configured for RLM and transmitted in the same beams as compared to the DL control channels.

Similar to LTE RLM, the UE may check DMRS quality at predefined time periods, such as every 10 ms, to get one measurement sample at L1 and then, every 200 ms, give one out-of-sync indication to L3. Since these DMRS only appear when the UE is scheduled, it is possible that at some time instance when the UE wants to monitor DMRS for RLM, DMRS is not there. In order to avoid such a situation, where the UE would measure a very low quality of DMRS and use that for RLM out-of-sync judgment (when the network actually does not send DMRS at all in that time instance), the measurement on DMRS may be accompanied with a cyclic redundancy code (CRC) check. That is, the UE will use the corresponding DMRS quality for in-sync/out-of-sync judgment, but only when the CRC check is correct.

In some embodiments, the control channel message is a dummy control channel message targeted to the UE but contains no scheduling information for the UE. This may enable the access node to provide the UE-specific RS as DMRS for PDCCH even when the UE is not scheduled. As a result, the UE may be able to perform RLM even when it is not scheduled. However, as the search space of PDCCH is limited and shared by all UEs in the “cell”, the access node 30 may not transmit a dummy PDCCH to the UE if this affects the normal scheduling of other UEs. Therefore, the access node 30 may be configured to transmit a dummy PDCCH only when there is still room in the PDCCH search space. A CRC check may also be necessary to see if the measurement of DMRS can be used for RLM.

In the above cases where the UE-specific RS may include DMRS in a control channel region or where the access node 30 transmits a dummy control channel region, the access node 30 may be able to refrain from using explicit signaling to the UE for DMRS to be measured. This may be when they are the same as when the UE detects the control channel region.

When the access node 30 transmits DMRS to the UE periodically, there may not be any PDCCH to accompany the DMRS. Also, the DMRS may occupy the same resource as when it is accompanied with PDCCH. In order to avoid wrong assumptions by the UE, the access node 30 may explicitly notify the UE at which subframe/resource the DMRS will be transmitted in so that the UE only measures DMRS at those subframes/resources. A CRC check would then not be necessary. However, as those DMRS are still transmitted using the same resources as when accompanied with PDCCH, sometimes such resources may be limited. In this case, the DMRS for RLM may need to be prioritized over the DMRS normally used for scheduling. Therefore, in some embodiments, the UE-specific RS may not be associated with a control channel message for the UE, and configuration information is thus sent to the UE, specifying time-frequency resources carrying the UE-specific RS (or DMRS).

In some cases, the UE-specific RS may be in a control channel region of the downlink signal and occupy time-frequency resources corresponding to those that would be used if a control channel message for the UE were included in the control channel region. In other cases, the UE-specific RS is adjacent, with respect to frequency and/or time, to a control channel region of the downlink signal. The UE-specific RS may further include DMRS in a control channel region of the downlink signal and associated with a control channel message for the UE, and the UE-specific RS are transmitted using the same beamforming parameters as applied to the control channel message.

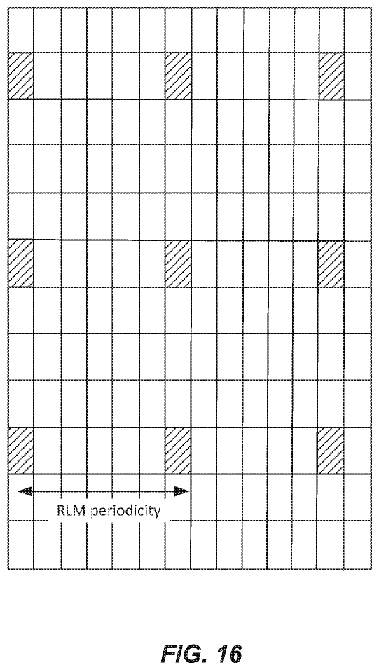

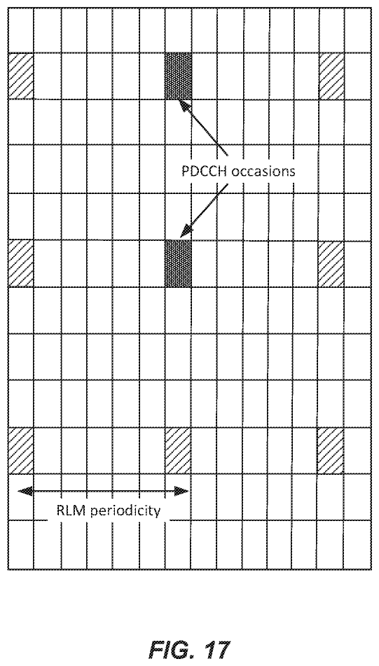

In an example, the access node 30 transmits DMRS to the UE periodically at the resources adjacent to PDCCH. FIG. 16 illustrates an example of the periodicity of DMRS transmissions. FIG. 17 illustrates an example of PDCCH transmissions locations with respect to the DMRS. The access node explicitly notifies the UE of the time and frequency where such DMRS are transmitted. The periodicity of such DMRS transmissions may be either fixed or adapted according to the PDCCH transmissions that were described above. This may include adding the use of an extra physical resource for signaling for RLM.

If the UE is not scheduled, the access node 30 may periodically transmit DMRS to the UE in resources adjacent to the control channel region. The access node 30 also notifies the UE when and where the DMRS will be. The periodicity of the DMRS may be affected by the transmission of the control channel region.

In the above cases where the UE-specific RS may be in or adjacent to a control channel region of the downlink signal and occupy corresponding time-frequency resources, the access node 30 may use explicit signaling to the UE as to when and/or where to measure DMRS.

Also, various combinations of the embodiments may be employed. For example, dummy control channel messages may still be used even when the UE is scheduled (if there is room available in the control channel region).

In these various cases, UE-specific beamforming may be assumed. The beamformer may choose or be chosen based on feedback (e.g., channel state information (CSI) or some other uplink signal) from the UE.

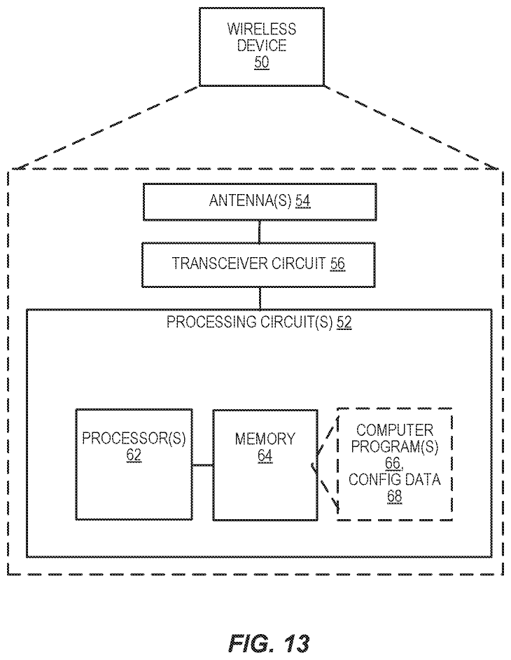

FIG. 13 illustrates a diagram of the corresponding UE, shown as wireless device 50. The wireless device 50 may be considered to represent any wireless terminals that may operate in a network, such as a UE in a cellular network. Other examples may include a communication device, target device, device to device (D2D) UE, machine type UE or UE capable of machine to machine communication (M2M), a sensor equipped with UE, PDA (personal digital assistant), Tablet, mobile terminal, smart phone, laptop embedded equipped (LEE), laptop mounted equipment (LME). USB dongles, Customer Premises Equipment (CPE), etc.

The wireless device 50 is configured to communicate with a radio node or base station in a wide-area cellular network via antennas 54 and a transceiver circuit 56. The transceiver circuit 56 may include transmitter circuits, receiver circuits, and associated control circuits that are collectively configured to transmit and receive signals according to a radio access technology, for the purposes of using cellular communication services. This radio access technology is NR for the purposes of this discussion.

The wireless device 50 also includes one or more processing circuits 52 that are operatively associated with the radio transceiver circuit 56. The processing circuit 52 comprises one or more digital processing circuits, e.g., one or more microprocessors, microcontrollers, DSPs, FPGAs, CPLDs. ASICs, or any mix thereof. More generally, the processing circuit 52 may comprise fixed circuitry, or programmable circuitry that is specially adapted via the execution of program instructions implementing the functionality taught herein, or may comprise some mix of fixed and programmed circuitry. The processing circuit 52 may be multi-core.

The processing circuit 52 also includes a memory 64. The memory 64, in some embodiments, stores one or more computer programs 66 and, optionally, configuration data 68. The memory 64 provides non-transitory storage for the computer program 66 and it may comprise one or more types of computer-readable media, such as disk storage, solid-state memory storage, or any mix thereof. By way of non-limiting example, the memory 64 comprises any one or more of SRAM, DRAM, EEPROM, and FLASH memory, which may be in the processing circuit 52 and/or separate from processing circuit 52. In general, the memory 64 comprises one or more types of computer-readable storage media providing non-transitory storage of the computer program 66 and any configuration data 68 used by the user equipment 50. The processing circuit 52 may be configured, e.g., through the use of appropriate program code stored in memory 64, to carry out one or more of the methods and/or signaling processes detailed hereinafter.

The wireless device 50 is configured, according to some embodiments, to measure a serving cell quality where the cell (e.g., access node 30) is transmitting signals in a beamforming manner. Accordingly, the processing circuit 52 is configured to receive, in a downlink signal having a series of subframes, a beam-formed reference signal in each of a plurality of subframes, where the beam-formed reference signals are received in fewer than all of the subframes of the downlink signal. The processing circuit 52 is also configured to receive a UE-specific RS, which may be different than the beam-formed reference signals. The processing circuit 52 is also configured to perform mobility management measurements using the beam-formed reference signals and performing RLM using the UE-specific RS.

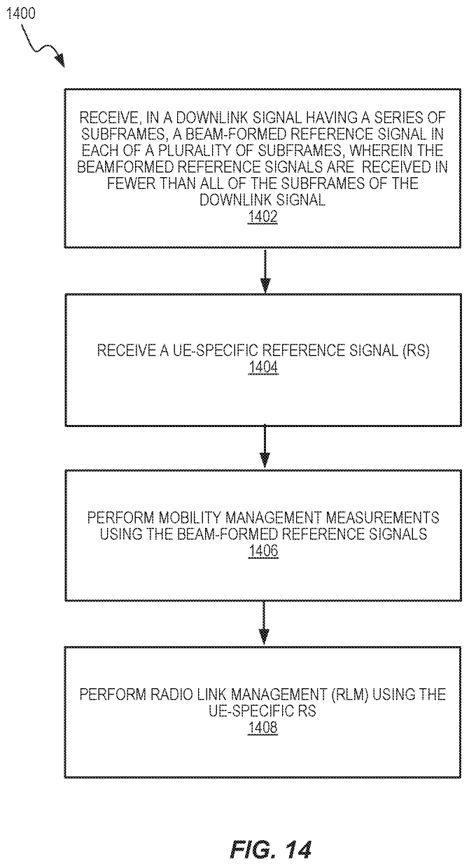

According to some embodiments, the processing circuit 52 performs a method 1400, as shown in FIG. 14. The method 1400 includes receiving, in a downlink signal having a series of subframes, a beam-formed reference signal in each of a plurality of subframes, where the beam-formed reference signals are received in fewer than all of the subframes of the downlink signal (block 1402). The method 1400 also includes receiving a UE-specific RS (block 1404), which may be different from the beam-formed reference signal. The method 1400 further includes performing mobility management measurements using the beam-formed reference signals (block 1406) and performing RLM using the UE-specific RS (block 1408). Performing RLM may include determining that the wireless device 50 is in-sync or out-of-sync, based on measurements of the UE-specific RS.

Various embodiments of the wireless device 50 may correspond to the respective embodiments discussed above for the access node 30. For example, the UE-specific RS may include DMRS in a control channel region of the downlink signal and associated with a control channel message for the wireless device 50. The method 1400 may further include demodulating the control channel message, using the DMRS, and verifying a CRC checksum for the control channel message before using the associated DMRS for RLM. The demodulating is based on an assumption that the DMRS are transmitted using the same beamforming parameters as applied to the control channel message.

In some cases, the control channel message is a dummy control channel message targeted to the wireless device 50 but contains no scheduling information for the wireless device 50.

In other cases, the UE-specific RS is not associated with a control channel message for the wireless device, and the method 1400 further includes receiving, from the wireless network (e.g., access node 30), configuration information specifying time-frequency resources carrying the UE-specific RS. In some cases, the UE-specific RS may be in a control channel region of the downlink signal, and occupy time-frequency resources corresponding to those that would be used if a control channel message for the wireless device 50 were included in the control channel region. In other cases, the UE-specific RS is adjacent, with respect to frequency and/or time, to a control channel region of the downlink signal. In these cases, the UE-specific RS further includes DMRS in a control channel region of the downlink signal and associated with a control channel message for the wireless device 50. The method 1400 may then further include demodulating the control channel message, using the DMRS, and verifying a CRC checksum for the control channel message before using the associated DMRS for RLM.

In sum, the techniques described herein provide a configurable and dynamic method to perform reference signal measurements for the RLM function at wireless devices, without violating the lean signaling principles of 3GPP 5G NR. An important advantage enabled by these techniques is an improved efficiency at which the network can flexibly configure a limited number of sparse reference signals for different deployment (e.g., number of beams) and traffic (e.g., number of users, data activity/inactivity) scenarios.

As discussed in detail above, the techniques described herein, e.g., as illustrated in the process flow diagrams of FIGS. 12 and 14, may be implemented, in whole or in part, using computer program instructions executed by one or more processors. It will be appreciated that a functional implementation of these techniques may be represented in terms of functional modules, where each functional module corresponds to a functional unit of software executing in an appropriate processor or to a functional digital hardware circuit, or some combination of both.

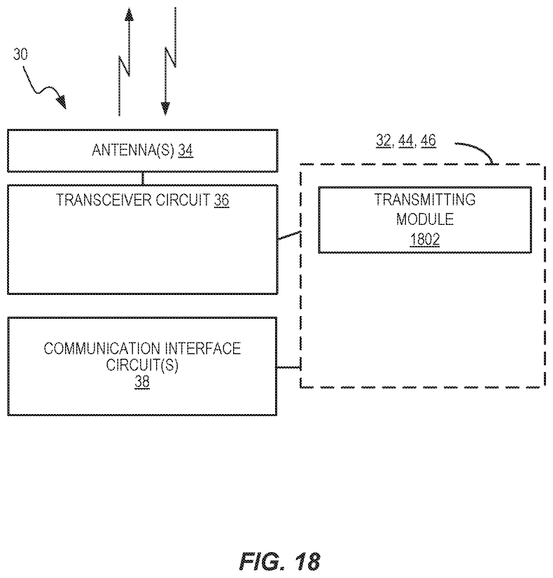

FIG. 18 illustrates an example functional module or circuit architecture as may be implemented in an access node of a wireless communication network, such as in network node 30. The functional implementation includes a transmitting module 1802 for transmitting, in a downlink signal having a series of subframes, a beam-formed reference signal in each of a plurality of subframes, where the beam-formed reference signals are received in fewer than all of the subframes of the downlink signal and are for use by one or more UEs in performing mobility management. The transmitting module 1802 is also for transmitting, for a first UE, a UE-specific RS, which may be different than the beam-formed reference signals, for use by the first UE in performing RLM.

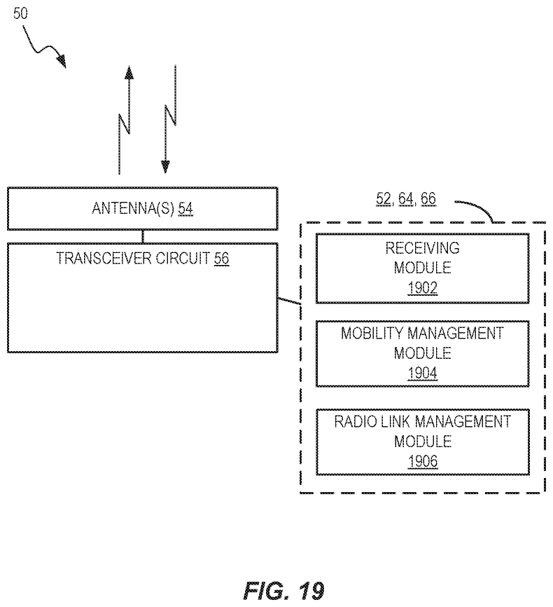

FIG. 19 illustrates an example functional module or circuit architecture as may be implemented in a wireless device 50 adapted for operation in a wireless communication network. The implementation includes a receiving module 1902 for receiving, in a downlink signal having a series of subframes, a beam-formed reference signal, in each of a plurality of subframes, where the beam-formed reference signals are received in fewer than all of the subframes of the downlink signal. The receiving module 1902 is also for receiving a UE-specific RS. The implementation also includes a mobility management module 1904 for performing mobility management measurements using the beam-formed reference signals and a radio link monitoring module 1906 for performing RLM using the UE-specific RS.

The present invention may, of course, be carried out in other ways than those specifically set forth herein without departing from essential characteristics of the invention. The present embodiments are to be considered in all respects as illustrative and not restrictive.

1-50. (canceled)

51. A method, in a user equipment (UE) operating in a wireless network, comprising:
receiving, in a downlink signal having a series of subframes, a UE-specific reference signal (RS); and
performing radio link monitoring (RLM) using the UE-specific RS.

52. A method, in an access node of a wireless communications system, the method comprising:
configuring, for a wireless device, a UE-specific reference signal (RS); and
transmitting to the wireless device, in a downlink signal having a series of subframes, the UE-specific RS, for use by the wireless device in performing radio link monitoring (RLM).

53. A user equipment (UE) configured for operation in a wireless communication network, the UE comprising:
transceiver circuitry; and
processing circuitry operatively associated with the transceiver circuitry and configured to:
receive, using the transceiver circuitry, in a downlink signal having a series of subframes, a UE-specific reference signal (RS); and
perform radio link monitoring (RLM) using the UE-specific RS.

54. The UE of claim 53, wherein the processing circuitry is further configured to:
receive a beam-formed reference signal in each of a plurality of subframes, using the transceiver circuitry, such that the beam-formed reference signals are received in fewer than all of the subframes of the downlink signal; and
perform mobility management measurements using the beam-formed reference signals.

55. The UE of claim 54, wherein the beam-formed reference signals are different from the UE-specific RS.

56. The UE of claim 53, wherein the UE-specific RS are in a control channel region of the downlink signal and associated with a control channel message for the UE.

57. The UE of claim 56, wherein the processing circuitry is configured to demodulate the control channel message, using the UE-specific RS, and verify a cyclic redundancy code (CRC) checksum for the control channel message before using the associated UE-specific RS for RLM, the demodulating being based on an assumption that the UE-specific RS are transmitted using the same beamforming parameters as applied to the control channel message.

58. The UE of claim 55, wherein the control channel message is a dummy control channel message targeted to the UE but contains no scheduling information for the UE.

59. The UE of claim 56, wherein the UE-specific RS comprises demodulation reference symbols (DMRS).

60. The UE of claim 53, wherein the processing circuitry is configured to receive, from the wireless network, configuration information specifying time-frequency resources carrying the UE-specific RS.

61. The UE of claim 60, wherein the UE-specific RS is in a control channel region of the downlink signal, and occupies time-frequency resources corresponding to those that would be used if a control channel message for the UE were included in the control channel region.

62. The UE of claim 60, wherein the UE-specific RS is adjacent, with respect to frequency and/or time, to a control channel region of the downlink signal.

63. The UE of claim 62, wherein the UE-specific RS further comprises demodulation reference symbols (DMRS) in a control channel region of the downlink signal and associated with a control channel message for the UE.

64. The UE of claim 63, wherein the processing circuitry is configured to demodulate the control channel message, using the DMRS, and verify a cyclic redundancy code (CRC) checksum for the control channel message before using the associated DMRS for RLM.

65. The UE of claim 53, wherein the processing circuitry is configured to perform RLM by determining that the UE is in-sync or out-of-sync, based on measurements of the UE-specific RS.

66. An access node of a wireless communications system, comprising:
transceiver circuitry; and
processing circuitry operatively associated with the transceiver circuitry and configured to:
configure, for a wireless device, a UE-specific reference signal (RS); and
transmit to the wireless device, using the transceiver circuitry, in a downlink signal having a series of subframes, the UE-specific reference RS, for use by the UE in performing radio link monitoring (RLM).

67. The access node of claim 66, wherein the processing circuitry is further configured to:
transmit a beam-formed reference signal in each of a plurality of subframes, using the transceiver circuitry, wherein the beam-formed reference signals are transmitted in fewer than all of the subframes of the downlink signal, for use by one or more user equipments (UEs) in performing mobility management.

68. The access node of claim 66, wherein the beam-formed reference signals are different from the UE-specific RS.

69. The access node of claim 66, wherein the UE-specific RS are in a control channel region of the downlink signal and associated with a control channel message for the UE, and wherein the processing circuitry is configured to transmit the UE-specific RS using the same beamforming parameters as applied to the control channel message.

70. The access node of claim 69, wherein the control channel message is a dummy control channel message targeted to the UE but contains no scheduling information for the UE.

71. The access node of claim 69, wherein the UE-specific RS comprises demodulation reference symbols (DMRS).

72. The access node of claim 66, wherein the processing circuitry is configured to send, to the UE, configuration information specifying time-frequency resources carrying the UE-specific RS.

73. The access node of claim 72, wherein the UE-specific RS is in a control channel region of the downlink signal and occupies time-frequency resources corresponding to those that would be used if a control channel message for the UE were included in the control channel region.

74. The access node of claim 72, wherein the UE-specific RS is adjacent, with respect to frequency and/or time, to a control channel region of the downlink signal.

75. The access node of claim 74, wherein the UE-specific RS further comprises demodulation reference symbols (DMRS) in a control channel region of the downlink signal and associated with a control channel message for the UE, and wherein the UE-specific RS are transmitted using the same beamforming parameters as applied to the control channel message.

76. A non-transitory computer readable storage medium storing a computer program comprising program instructions that, when executed on at least one processing circuit of a user equipment (UE) configured for operation in a wireless communication network, configure the UE to:
receive, in a downlink signal having a series of subframes, a UE-specific reference signal (RS); and
perform radio link monitoring (RLM) using the UE-specific RS.

77. A non-transitory computer readable storage medium storing a computer program comprising program instructions that, when executed on at least one processing circuit of an access node of a wireless communication network, configures the access node to:
configure, for a wireless device, a UE-specific reference signal (RS); and
transmit to the wireless device, in a downlink signal having a series of subframes, the UE-specific RS, for use by the wireless device in performing radio link monitoring (RLM).
